(19) United States
(12) Patent Application Publication
(10) Pub. No.: US 2008/0081159 A1
(43) Pub. Date: Apr. 3, 2008

(54) COVER WITH A SOFT SURFACE

(75) Inventors: DA-QING HUANG, Shenzhen (CN); MING LI, Shenzhen (CN); LIANG-FU ZHANG, Shenzhen (CN); ZHI-SAN XU, Shenzhen (CN); YUAN SUN, Shenzhen (CN); QIANG LI, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: SHENZHEN FUTAIHONG PRECISION INDUSTRIAL CO,.LTD., Shenzhen (CN); SUTECH TRADING LIMITED, Tortola (VG)

(21) Appl. No.: 11/682,777

(22) Filed: Mar. 6, 2007

(30) Foreign Application Priority Data
Sep. 29, 2006 (CN) 200610062908.0

(51) Int. Cl. B41M 5/00

(52) U.S. Cl. 428/195.1

(57) ABSTRACT

A durable cover with a soft surface device (100) includes a substrate (10), an intermediate layer (20), an ink coating (30), and a top coating (40). The intermediate layer is made of a polyurethane paint. The ink coating contains a polyurethane component. The top coating is made of a polyurethane adhesive. The intermediate layer is applied onto the substrate, the ink coating is formed on the surface of the intermediate layer, and the top layer is formed on the surface of the ink coating and the intermediate layer. The presence of polyurethane in the intermediate layer, the ink coating, and the top coating promotes partial cross-linking therebetween and, thus, helps improve the durability of the cover. Further, the polyurethane contributes positively to the overall softness and flexibility of the cover.

### BACKGROUND OF THE INVENTION

1. Field of the Invention

The present invention relates to covers for mobile devices and, particularly, to a cover with a soft surface.

2. Description of Related Art

Mobile devices, such as mobile telephones, personal digital assistants, or MP3 players, enable consumers to enjoy the convenience of high technology services, anytime and at virtually any location. These mobile devices often employ any of a variety of decorative covers to attract consumers. Paints and inks are typically applied onto surfaces of the covers to provide the necessary decorative appearance. Nowadays, covers, which appear attractive not only to the eye but which also, have attractive tactile characteristics, such as soft covers, are highly desirable. Processes for the production of the soft covers, in which a soft material is applied to the covers, are known, and the soft material used in such processes is typically flexible resin.

In order to obtain desired decorative appearances, pictures, or patterns are typically made on the covers by applying ink onto the flexible resin coating. However, most ink poorly adheres to the flexible resin coating, and the ink can easily wear away.

Therefore, a durable cover with a soft surface is desired in order to overcome the above-described shortcomings.

### SUMMARY OF THE INVENTION

In one embodiment thereof, a durable cover with a soft surface is provided. The cover includes a substrate, an intermediate layer, an ink coating, and a top coating. The intermediate layer is made of a polyurethane paint. The ink coating contains a polyurethane component. The top coating is made of a polyurethane adhesive. The intermediate layer is applied onto the substrate and in contact therewith, the ink coating is directly formed on the surface of the intermediate layer, and the top layer is deposited directly at least on the surface of the ink coating and, optionally, directly on the intermediate layer.

Other advantages and novel features will become more apparent from the following detailed description of preferred embodiments when taken in conjunction with the accompanying drawings.

### BRIEF DESCRIPTION OF THE DRAWINGS

Many aspects of the cover with a soft surface can be better understood with reference to the following drawing. The components in the drawing are not necessarily drawn to scale, the emphasis instead being placed upon clearly illustrating the principles of the cover with a soft surface. Moreover, in the drawing like reference numerals designate corresponding parts throughout the several views.

FIG. 1 is a cut-away view of a preferred embodiment of a cover with a soft surface.

### DETAILED DESCRIPTION OF THE INVENTION

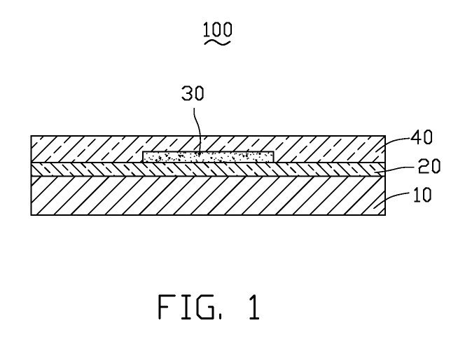

Referring to FIG. 1, in a preferred embodiment, a cover 100 includes a substrate 10, an intermediate layer 20, an ink coating 30, and a top layer 40. The intermediate layer 20 is applied directly onto the substrate 10. Meanwhile, the ink coating 30 is formed in contact with the surface of the intermediate layer 20 opposite the substrate 10. Finally, the top layer 40 is formed directly on the surface of the ink coating 30 and, optionally, on the intermediate layer 20, if the ink coating 30 does not itself cover the entirety of the intermediate layer 20. It should be understood, of course, that the top layer 40 could just be applied onto the surface of the ink coating 30.

The substrate 10 is preferably made of a plastic material. The plastic material can be chosen from the group including acrylonitrile butadiene styrene polymer, polyethylmethacrylate, polycarbonate, polymethyl methacrylate, polystyrene, and any desired combination thereof. It is, of course, to be understood that the substrate 10 could be made of metal such as steel, titanium, or aluminum. Such factors as the substrate material and thickness will help determine the flexibility displayed by the substrate 10.

The intermediate layer 20 advantageously is made of a flexible paint, which includes a flexible resin as major constituent (e.g., about 10% by weight). The flexible resin is a polyurethane resin and preferably should be a polyether-urethane resin. The intermediate layer 20 may, usefully, be formed via spray painting the flexible paint onto the surface of the substrate 10. The flexible paint may contain, e.g., polyurethane prepolymer, flexible resin powder, and silicone oil. The polyurethane prepolymer may be obtained by the reaction of isocynate and polyether polyol and, preferably, should be obtained by the reaction of diisocynate and polyether diol. The flexible resin powder is, beneficially, composed of polymerized urethane resin particles, which is used in an approximate portion of 8 to 12 wt % and should preferably be about 10 wt % of the flexible paint. The flexible resin powder is added to the flexible paint for improving flexibility of the intermediate layer 20. The silicone oil is, opportunely, polyorganosiloxane or a modified polyorganosiloxane, which is added as a surfactant in an approximate portion of 3 to 5 wt %. The silicone oil should preferably be 4 wt % of the flexible paint.

A process for forming the ink coating 30 onto the surface of the intermediate layer 20 may, for example, be carried out via screen printing or stencil printing, so as to form designs, such as pictures or patterns. The ink used in the process may include a resin component to improve its ability to bond with the other layers. The resin can, e.g., be polyurethane and should preferably be polyether-urethane. During the process of forming the ink coating 30, the polyurethane component contained in the ink is, advantageously, partially cross-linked with the polyurethane component contained in the intermediate layer 20, so as to improve adhesion of the ink coating 30 to the intermediate layer 20.

The top layer 40 is beneficially made of transparent adhesive, which may, for example, be a one-component polyurethane adhesive, to permit optimal viewing of the ink coating 30. Such a polyurethane adhesive is cured (e.g., using heat and/or UV) so as to form the top layer 40. The adhesive contains polyurethane prepolymer as a major component, which is obtained by the reaction of isocynate and polyether polyol and, more preferably, by the reaction of diisocynate and polyether diol. The adhesive includes toluene, xylene, methyl ethyl ketone, methoxy propyl acetate, or mixture thereof as a solvent. It is, of course, to be understood that the adhesive could be two-component polyurethane adhesive, which has an epoxy component added for improving the durability of the top layer 40.

A process for forming the top layer 40 may be carried out, e.g., via spray painting, dipping, or brushing. During the process of forming the top layer 40, the polyurethane component contained in the adhesive is partially cross-linked with the polyurethane component contained in the ink coating 30 and/or partially cross-linked with the polyurethane component contained in and the intermediate layer 20 not covered by the ink coating 30. Such partial cross-linking improves adhesion of the top layer 40 to the ink coating 30 and/or the intermediate layer 20 and thereby promotes the durability of the cover 100. The adhesive coating also functions as a protective layer for preventing the ink coating 30 from being worn/abraded away. Further, the presence of polyurethane in the layers 20, 30, 40 contributes positively to the overall softness and flexibility of the cover 100.

It should be understood, of course, that the substrate 10 could also be coated with a color resin before forming the intermediate layer 20 thereon, so as to improve the decorative appearance of the cover 100.

The intermediate layer 20 can also instead be made of a transparent adhesive, and, accordingly, the top layer 40 instead be made of the flexible paint.

It should be also understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cover with a soft surface, comprising:
a substrate;
an intermediate layer made of a polyurethane paint;
an ink coating containing a polyurethane component; and
a top coating made of a polyurethane adhesive;
wherein the intermediate layer is applied onto the substrate, the ink coating is formed on a surface of the intermediate layer, and the top layer is formed on a surface of at least one of the ink coating and the intermediate layer.

2. The cover as claimed in claim 1, wherein the substrate is made one of a plastic material and a metal.

3. The cover as claimed in claim 1, wherein the polyurethane paint contains a polyurethane prepolymer, a flexible resin powder, and a silicone oil.

4. The cover as claimed in claim 3 wherein the flexible resin powder is composed of polymerized urethane resin particles.

5. The cover as claimed in claim 3 wherein the flexible resin powder is used in an approximate portion of 8 to 12 wt % of the flexible paint.

6. The cover as claimed in claim 3 wherein the silicone oil which is added as a surfactant in an approximate portion of 3 to 5 wt % of the flexible paint.

7. The cover as claimed in claim 3 wherein the polyurethane prepolymer is obtained one of by the reaction of isocynate and polyether polyol and by the reaction of diisocynate and polyether diol.

8. The cover as claimed in claim 1, wherein the ink coating contains a polyether-urethane resin.

9. The cover as claimed in claim 1, wherein the polyurethane adhesive is a one-component polyether-urethane adhesive obtained by the reaction of isocynate and polyether polyol.

10. The cover as claimed in claim 1, wherein the polyurethane adhesive a two-component polyether-urethane adhesive, which has an epoxy component added for improving durability of the top layer.

11. The cover as claimed in claim 1, wherein the polyurethane component contained in the ink coating is partially cross-linked with the polyurethane paint.

12. The cover as claimed in claim 1, wherein the polyurethane adhesive is partially cross-linked with the polyurethane component contained in the ink coating and/or with the polyurethane paint not covered by the ink coating.

13. A cover with a soft surface, comprising:
a substrate;
an intermediate layer made of a polyurethane adhesive;
an ink coating including a polyurethane component; and
a top coating made of a polyurethane paint;
wherein the intermediate layer is applied onto the substrate, the ink coating is formed on a surface of the intermediate layer, and the top layer is formed on a surface of the ink coating and the intermediate layer.

14. The cover as claimed in claim 13, wherein the polyurethane paint contains polyurethane prepolymer, flexible resin powder, and silicone oil.

15. The cover as claimed in claim 14, wherein the flexible resin powder is used in an approximate proportion of 8 to 12 wt % of the flexible paint.

16. The cover as claimed in claim 14, wherein the silicone oil which is added as a surfactant in an approximate portion of 3 to 5 wt % of the flexible paint.

17. The cover as claimed in claim 13, wherein the ink coating contains a polyether-urethane resin.

18. The cover as claimed in claim 13, wherein the polyurethane component contained in the ink coating is partially cross-linked with the polyurethane paint.

19. The cover as claimed in claim 13, wherein the polyurethane adhesive is partially crosslinked with the polyurethane component contained in the ink coating and/or with the polyurethane paint not covered by the ink coating.
